(19) United States
(12) Patent Application Publication
(10) Pub. No.: US 2015/0364999 A1
(43) Pub. Date: Dec. 17, 2015

(54) SEMICONDUCTOR INTEGRATED CIRCUIT AND POWER SUPPLY

(71) Applicant: ROHM CO., LTD., Kyoto (JP)

(72) Inventor: Kiyoshi KONDO, Ukyo-ku (JP)

(21) Appl. No.: 14/739,756

(22) Filed: Jun. 15, 2015

(30) Foreign Application Priority Data
Jun. 16, 2014 (JP) 2014-123187

(51) Int. Cl. H02M 3/158

(52) U.S. Cl. CPC H02M 3/158

(57) ABSTRACT

A semiconductor integrated circuit includes: a die pad region; a plurality of external lead pins arranged around the die pad region; and DC/DC converters arranged in corners on the die pad region.

### CROSS-REFERENCE TO RELATED APPLICATION

The present invention claims priority under 35 U.S.C. §119 to Japanese Application No. 2014-123187, filed on Jun. 16, 2014, the entire content of which is incorporated herein by reference.

### TECHNICAL FIELD

The present disclosure relates to a semiconductor integrated circuit and a power supply.

### BACKGROUND

Notebook type personal computers (notebook PC) having a keyboard and a display screen that are interconnected via an openable/closable connection, and where the display screen is at a position at which the display screen stands up with respect to the keyboard when used, and the display screen is overlapped on the keyboard when not in use are known.

In addition, a tablet type personal computer (tablet PC) having a display screen on its top, having a form of a single plate, and inputting instructions by making an approach or contact to the display screen using a pen and recognizing the approach or contact position has been used.

Additionally, a bottom cover type electronic apparatus in which external parts such as external coils constituting a DC/DC converter are mounted on the rear surface of a mounting board having a semiconductor integrated circuit thereon has also been disclosed.

### SUMMARY

The present disclosure provides embodiments of a semiconductor integrated circuit which is capable of suppressing parasitic impedance occurring between connections of the semiconductor integrated circuit and external parts, and a power supply including the semiconductor integrated circuit.

According to one embodiment of the present disclosure, there is provided a semiconductor integrated circuit including: a die pad region; a plurality of external lead pins arranged in a peripheral region of the die pad region; and a DC/DC converter arranged in a corner region of the die pad region.

According to another embodiment of the present disclosure, there is provided a power supply including the above-described semiconductor integrated circuit.

### BRIEF DESCRIPTION OF THE DRAWINGS

FIG. 1 is a schematic view of a semiconductor integrated circuit and inductances arranged around the circuit according to a comparative example.

FIG. 2 is a schematic view of a semiconductor integrated circuit according to one embodiment of the present disclosure.

FIG. 3 is a diagram showing connection between an output circuit of a DC/DC converter mounted on a semiconductor integrated circuit and an external circuit according to one embodiment of the present disclosure.

FIG. 4 is a schematic view of a semiconductor integrated circuit and inductances connected to four DC/DC converters arranged in a corner region, according to one embodiment of the present disclosure.

FIG. 5 is a schematic view of a semiconductor integrated circuit, and inductances, output capacitances, and snubber capacitances connected to four DC/DC converters arranged in a corner region, according to one embodiment of the present disclosure.

FIG. 6 is a schematic view of an output circuit of a DC/DC converter mounted on a semiconductor integrated circuit, according to one embodiment of the present disclosure.

FIG. 7 is a detailed schematic view of a semiconductor integrated circuit, and inductances, output capacitances, and snubber capacitances connected to four DC/DC converters arranged in a corner region, according to one embodiment of the present disclosure.

### DETAILED DESCRIPTION

Embodiments of the present disclosure will now be described in detail with reference to the drawings. Throughout the drawings, the same or similar elements are denoted by the same or similar reference numerals. It should be noted that the drawings merely show the schematics, and thus, thickness, planar dimension of the elements, thickness ratio of various layers, etc. may be modified. Accordingly, the specific thickness and dimensions should be determined in consideration of the following descriptions. In addition, it is to be understood that the drawings include different dimensional relationships and ratios.

The following embodiments are provided to illustrate devices and methods to embody the technical ideas of the present disclosure and are not limited to materials, forms, structures, arrangements, etc. of elements herein. The embodiments of the present disclosure may be modified without departing from the spirit and scope of the invention defined in the claims.

### Comparative Example

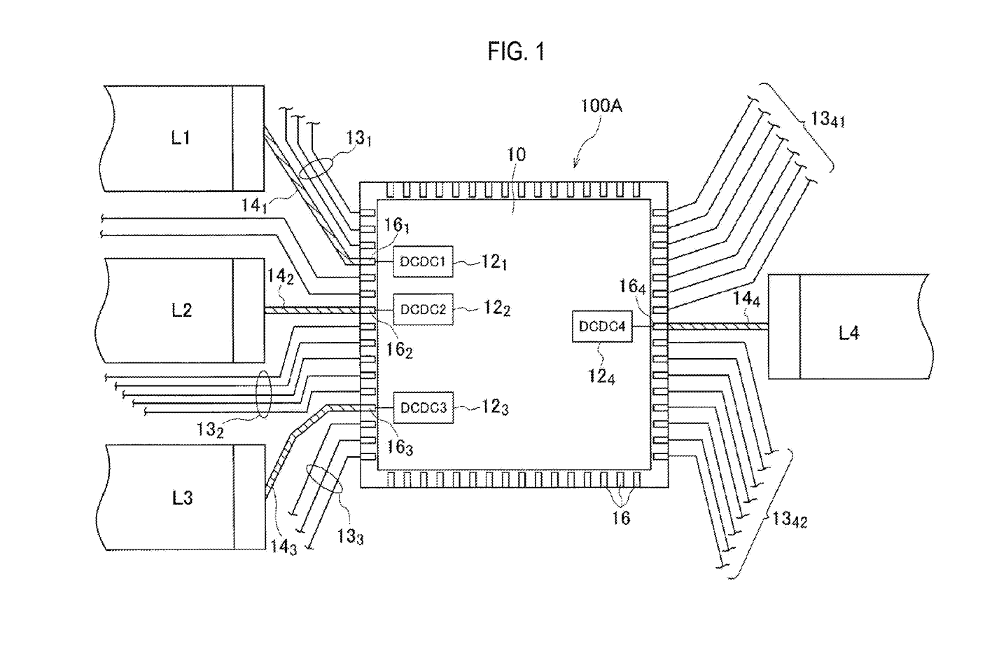

FIG. 1 is a schematic view of a semiconductor integrated circuit 100A and inductances L1, L2, L3, and L4 arranged in the vicinity of the circuit 100A according to a comparative example.

As shown in FIG. 1, the semiconductor integrated circuit 100A according to the comparative example includes a die pad region 10, DC/DC converter (DCDC1) 12₁·DC/DC converter (DCDC2) 12₂·DC/DC converter (DCDC2) 12₃·DC/DC converter (DCDC4) 12₄ arranged on the die pad region 10, and external lead pins 16 arranged in a periphery region of the die pad region 10.

For example, an output of the DC/DC converter 12₁ is connected to an external lead pin 16₁ that is connected to an external inductance L1 via a power wiring 14₁. In a similar manner, outputs of the DC/DC converters 12₂, 12₃, and 12₄ are respectively connected to external lead pins 16₂, 16₃, and 16₄ that are respectively connected to external inductances L2, L3, and L4 via power wirings 14₂, 14₃, and 14₄. As shown in FIG. 1, other external lead pins 16 are connected to signal wirings 13₁, 13₂, 13₃, 13₄₁, and 13₄₂ other than the power wirings.

As shown in FIG. 1, when the DC/DC converters 12₁, 12₂, and 12₃ are arranged side by side on one side of the semiconductor integrated circuit 100A, external parts such as the external inductances L2, L3, and L4 needs to be mounted apart from the semiconductor integrated circuit 100A because of their large size.

In addition, it is difficult to form the power wirings 14₁, 14₂, 14₃, and 14₄ that connect the DC/DC converters 12₁, 12₂, 12₃, and 12₄ and the external parts widely since these power wirings may make contact with other signal wirings 13₁, 13₂, 13₃, 13₄₁, and 13₄₂ connected to the semiconductor integrated circuit 100A.

Accordingly, wirings connecting the DC/DC converters 12₁, 12₂, 12₃, and 12₄ and the external parts are likely to be made thin and long. As a result, impedances of the power wirings 14₁, 14₂, 14₃, and 14₄ connecting the DC/DC converters 12₁, 12₂, 12₃, and 12₄ and the external parts are likely to increase and the performance of the DC/DC converters 12₁, 12₂, 12₃, and 12₄ is likely to deteriorate, e.g., decrease in efficiency thereof. In addition, radiation noise according to switching noise occurring in the wiring portion connecting the DC/DC converters 12₁, 12₂, 12₃, and 12₄ and the external parts is likely to increase.

### Embodiments

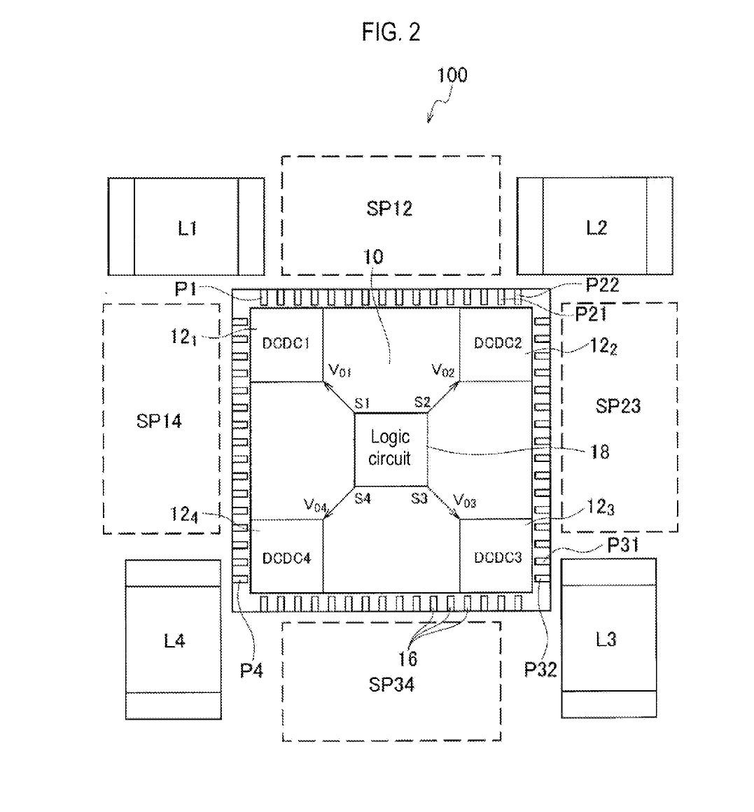

FIG. 2 is a schematic view of a semiconductor integrated circuit according to one embodiment of the present disclosure.

As shown in FIG. 2, a semiconductor integrated circuit 100 includes a die pad region 10, DC/DC converters 12₁, 12₂, 12₃, and 12₄ arranged in a corner portion of the die pad region 10, and external lead pins 16 arranged in a periphery portion of the die pad region 10.

As shown in FIG. 2, in the semiconductor integrated circuit 100, by arranging the DC/DC converters 12₁, 12₂, 12₃, and 12₄ in the corner portion of the die pad region 10, external parts such as inductances L1, L2, L3, and L4 may be arranged in the vicinity of the semiconductor integrated circuit 100.

As shown in FIG. 2, the semiconductor integrated circuit 100 includes a logic circuit 18 disposed on the die pad region 10. The logic circuit 18 may supply control signals S1, S2, S3, and S4 having respective output voltages V₀₁, V₀₂, V₀₃, and V₀₄ to the DC/DC converters 12₄, 12₂, 12₃, and 12₄ arranged in the corner portion.

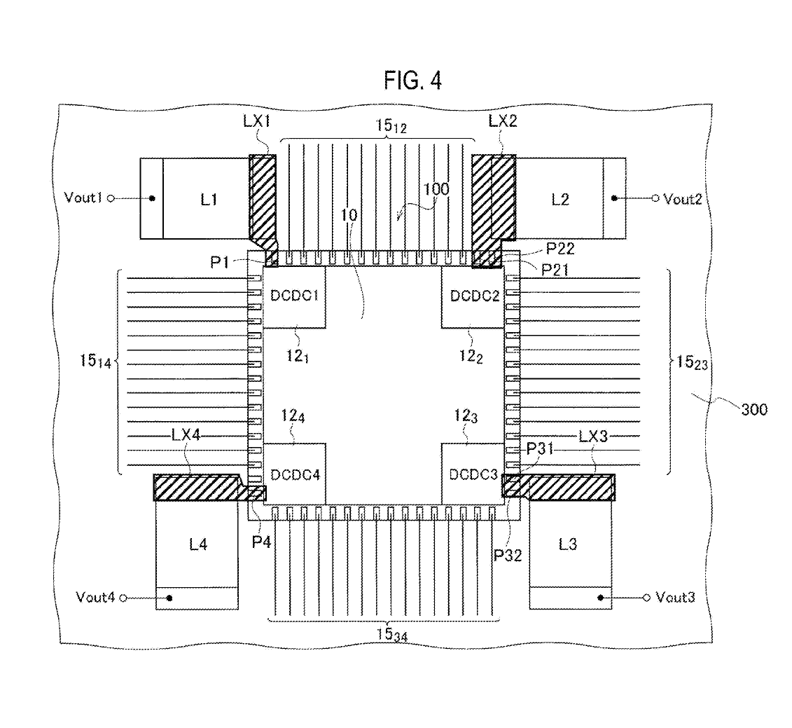

As shown in FIG. 4 to be described later, the semiconductor integrated circuit 100 and the external parts such as the inductances L1, L2, L3 and L4 are arranged on a printed circuit board (PCB) 300.

In addition, among the plurality of external lead pins 16, external lead pins that are not connected to the outputs of the DC/DC converters 12₁, 12₂, 12₃, and 12₄ may provide space for mounting other wirings or parts on the printed circuit board 300. That is, as shown in FIG. 2, the semiconductor integrated circuit 100 may secure spaces SP12, SP23, SP34 and SP14 for mounting other wirings and parts.

The output of the DC/DC converter 12₁ may be connected to an external lead pin P1, the output of the DC/DC converter 12₂ may be connected to external lead pins P21 and P22, the output of the DC/DC converter 12₃ may be connected to external lead pins P31 and P32, and the output of the DC/DC converter 12₄ may be connected to an external lead pin P4. For example, since the output of the DC/DC converter 12₁ may be about 1 A, it may be connected to one external lead pin P1. Since the output of the DC/DC converter 12₂ may be about 2 A, it may be connected to two external lead pins P21 and P22. Similarly, since the output of the DC/DC converter 12₃ may be about 2 A, it may be connected to two external lead pins P31 and P32. Since the output of the DC/DC converter 12₄ may be about 1 A, it may be connected to one external lead pin P4 for conduction of about 1 A. That is, depending on the current capacity, one or more external lead pins may be connected to the outputs of the DC/DC converters.

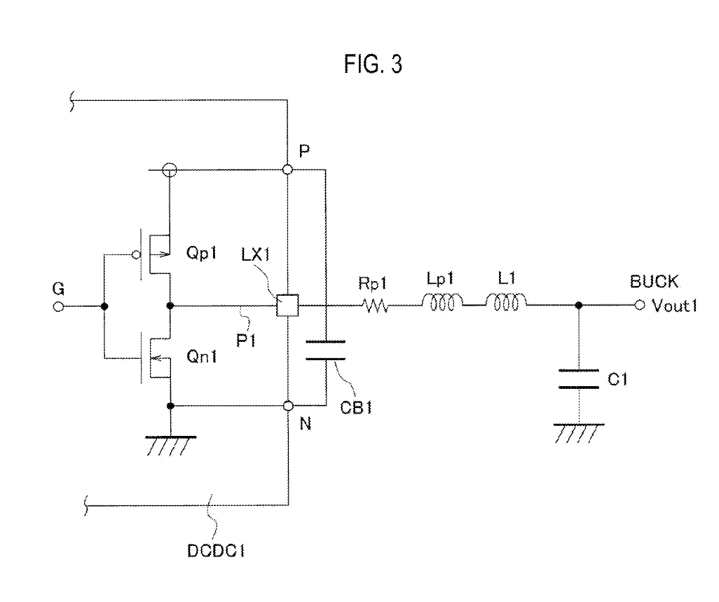

FIG. 3 is a diagram showing a connection between an output circuit of the DC/DC converter 12₁ mounted on the semiconductor integrated circuit 100 and an external circuit according to one embodiment of the present invention.

One example of the output circuit of the DC/DC converter (DCDC1) 12₁ has a complementary circuit configuration including a p channel MOSFET Qp1 and an n channel MOSFET Qn1, as shown in FIG. 3. A source of the p channel MOSFET Qp1 is connected to a power pin P and a source of the n channel MOSFET Qn1 is connected to a ground (GND) pin N. An output of the DC/DC converter 12₁ is drawn from a drain of the p channel MOSFET Qp1 and a drain of the n channel MOSFET Qn1.

The output of the DC/DC converter 12₁ is connected to an external lead pin P1 which is then connected to one electrode of an external inductance L1 via a power wiring LX1. The other electrode of the external inductance L1 is connected to an output capacitor C1 interposed between the external inductance L1 and a ground potential and an output voltage Vout1 is drawn from both ends of the output capacitor C1.

In addition, as shown in FIG. 3, a snubber capacitor CB1 is connected between the power pin P and the GND pin N of the DC/DC converter 12₁. In addition, as shown in FIG. 3, the power wiring LX1 connected to the external lead pin P1 has parasitic wiring inductance Lp1 and parasitic wiring resistance Rp1. Therefore, the external circuit connected to the external lead pin P1 of the DC/DC converter 12₁ is constituted by the external inductance L1 and the output capacitor C1, as shown in FIG. 3.

In the semiconductor integrated circuit 100, since the power wiring LX1 may be connected to the output of the DC/DC converter 12₁ at the nearest point, it is possible to suppress the parasitic wiring inductance Lp1 and parasitic wiring resistance Rp1 as compared to the comparative example.

FIG. 4 is a schematic view of the semiconductor integrated circuit 100 and the inductances L1, L2, L3, and L4 connected to the four DC/DC converters 12₁, 12₂, 12₃, and 12₄, according to one embodiment of the present disclosure. Herein, the semiconductor integrated circuit 100 and the inductances L1, L2, L3, and L4 are arranged on the PCB 300.

In addition, among the plurality of external lead pins 16, external lead pins that are not connected to outputs of the DC/DC converters 12₁, 12₂, 12₃, and 12₄ may provide spaces for mounting other wirings or parts on the printed circuit board 300. That is, since the semiconductor integrated circuit 100 may secure spaces SP12, SP23, SP34, and SP14 for mounting other wirings and parts, signal wirings 15₁₂, 15₂₃, 15₃₄ and 15₁₄ may be arranged on the PCB 300, as shown in FIG. 4.

As shown in FIG. 4, the output of the DC/DC converter 12₁ is connected to the inductance L1 via the external lead pin P1 and the power wiring LX1. Similarly, as shown in FIG. 4, the output of the DC/DC converter 12₂ is connected to the inductance L2 via the external lead pins P21 and P22 and the power wiring LX2, the output of the DC/DC converter 12₃ is connected to the inductance L3 via the external lead pins P31 and P32 and the power wiring LX3, and the output of the DC/DC converter 12₄ is connected to the inductance L4 via the external lead pin P4 and the power wiring LX4.

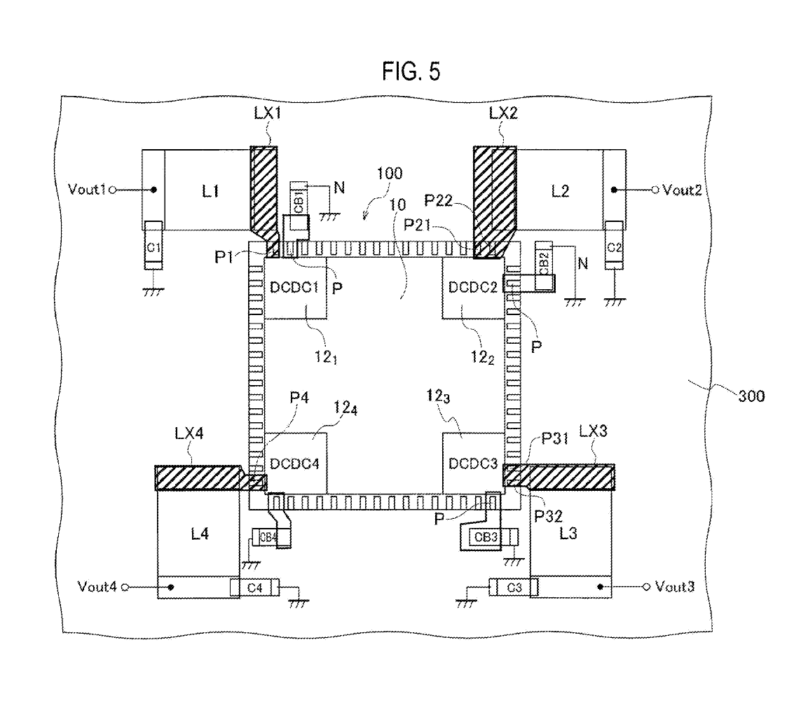

FIG. 5 is a schematic view of the semiconductor integrated circuit 100, and the inductances L1, L2, L3, and L4, output capacitances C1, C2, C3, and C4, and snubber capacitances CB1, CB2, CB3, and CB4, connected to the four DC/DC converters 12₁, 12₂, 12₃, and 12₄, according to one embodiment of the present disclosure. Herein, the semiconductor integrated circuit 100, the inductances L1, L2, L3, and L4, the output capacitances C1, C2, C3, and C4 and the snubber capacitances CB1, CB2, CB3, and CB4 are arranged on the PCB 300. The signal wirings 15₁₂, 15₂₃, 15₃₄, and 15₁₄ are not shown in FIG. 5 although they may be arranged on the PCB 300.

As shown in FIG. 5, the output of the DC/DC converter 12₁ is connected to one electrode of the external inductance L1 via the external lead pin P1 and the power wiring LX1. The output capacitor C1 is connected between the other electrode of the external inductance L1 and the ground potential and an output voltage Vout1 is drawn from both ends of the output capacitor C1. In addition, the snubber capacitor CB1 is connected between the power pin P and the GND pin N of the DC/DC converter 12₁.

Similarly, as shown in FIG. 5, the output of the DC/DC converter 12₂ is connected to one electrode of the external inductance L2 via the external lead pins P21 and P22 and the power wiring LX2. The output capacitor C2 is connected between the other electrode of the external inductance L2 and the ground potential, and an output voltage Vout2 is drawn from both ends of the output capacitor C2. In addition, the snubber capacitor CB2 is connected between the power pin P and the GND pin N of the DC/DC converter 12₂.

Similarly, as shown in FIG. 5, the output of the DC/DC converter 12₃ is connected to one electrode of the external inductance L3 via the external lead pins P31 and P32 and the power wiring LX3. The output capacitor C3 is connected between the other electrode of the external inductance L3 and the ground potential, and an output voltage Vout3 is drawn from both ends of the output capacitor C3. In addition, the snubber capacitor CB3 is connected between the power pin P and the GND pin N of the DC/DC converter 12₃.

Similarly, as shown in FIG. 5, the output of the DC/DC converter 12₄ is connected to one electrode of the external inductance L4 via the external lead pin P4 and the power wiring LX4. The output capacitor C4 is connected between the other electrode of the external inductance L4 and the ground potential and an output voltage Vout4 is drawn from both ends of the output capacitor C4. In addition, the snubber capacitor CB4 is connected between the power pin P and the GND pin N of the DC/DC converter 12₄.

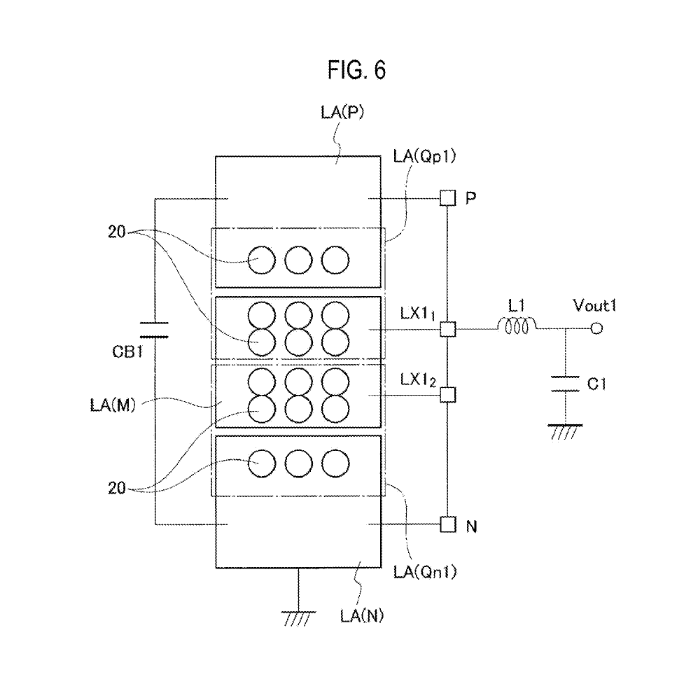

FIG. 6 shows a schematic view of an output circuit of the DC/DC converter 12₁ mounted on the semiconductor integrated circuit 100 according to one embodiment of the present disclosure.

As shown in FIG. 6, the schematic planar pattern configuration of an output circuit of the DC/DC converter 12₁ mounted on the semiconductor integrated circuit 100 is illustrated according to one embodiment of the present disclosure. The DC/DC converter 12₁ includes an active layer LA(Qp1) of the p channel MOSFET Qp1, an active layer LA(Qn1) of the n channel MOSFET Qn1, a source electrode layer LA(P) connected to the source of the p channel MOSFET Qp1, a source electrode layer LA(N) connected to the source of the n channel MOSFET Qn1, and an output electrode layer LA(M) connected in common to the drain of the p channel MOSFET Qp1 and the drain of the n channel MOSFET Qn1.

The source of the p channel MOSFET Qp1 is connected to the power pin P via three connections 20 and the source electrode layer LA(P) and the source of the n channel MOSFET Qn1 is connected to the GND pin N via three connections 20 and the source electrode layer LA(N). The drain of the p channel MOSFET Qp1 and the drain of the n channel MOSFET Qn1 are respectively connected to two power wirings LX1₁ and LX1₂ via three connections 20 and the output electrode layer LA(M). For example, since the output of the DC/DC converter 12₁ is about 1 A, an output circuit (including the external inductance L1 and the capacitor C1) is connected to the power wiring LX1₁. Herein, the connections 20 represent areas for interconnecting overlapping electrode layers using a solder layer or a laser melting layer.

In addition, the snubber capacitor CB1 is connected between the source electrode layer LA(P) connected to the source of the p channel MOSFET Qp1 and the source electrode layer LA(N) connected to the source of the n channel MOSFET Qn1.

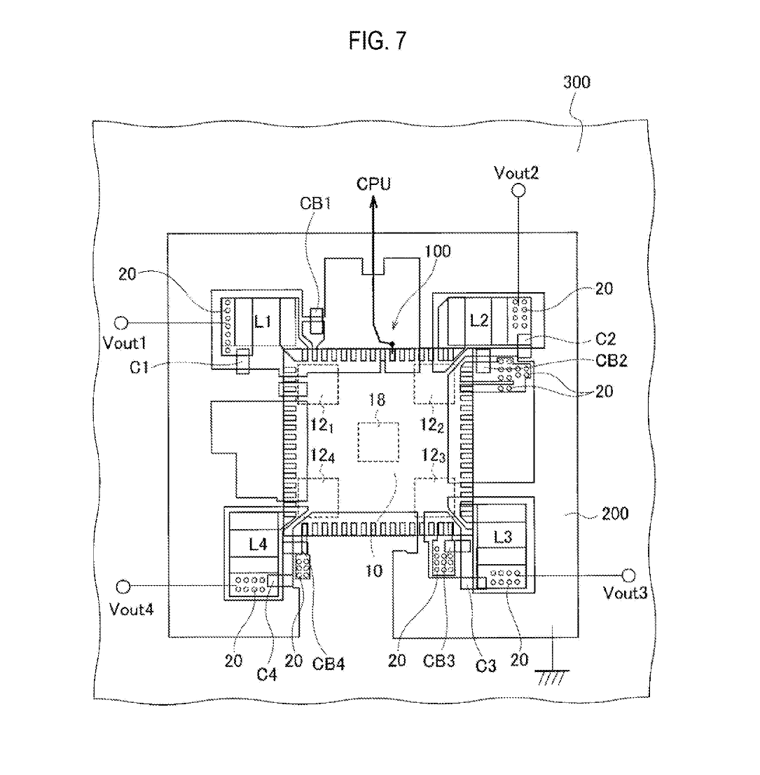

FIG. 7 is a detailed schematic view of the semiconductor integrated circuit, and the inductances L1, L2, L3, and L4, output capacitances C1, C2, C3, and C4, and snubber capacitances CB1, CB2, CB3, and CB4 connected to four DC/DC converters arranged in the corners, according to one embodiment of the present disclosure. The DC/DC converters 12₁, 12₂, 12₃, and 12₄ and the logic circuit 18 may be arranged on the die pad region 10 of the semiconductor integrated circuit 100. The semiconductor integrated circuit 100, the inductances L1, L2, L3, and L4, the output capacitances C1, C2, C3, and C4, and the snubber capacitances CB1, CB2, CB3, and CB4 are arranged on the PCB 300. Additionally, a ground electrode pattern 200 is arranged on the PCB 300. The signal wirings 15₁₂, 15₂₃, 15₃₄, and 15₁₄ are not shown in FIG. 7 although they may be arranged on the PCB 300. Other configurations are the same as those in FIG. 5.

The semiconductor integrated circuit may provide a floor plan of an integrated circuit (IC) for mounting of external parts. That is, it is possible to provide a semiconductor integrated circuit including a circuit (such as a DC/DC converter or the like) having large external parts such as inductances.

The semiconductor integrated circuit may be mounted on various types of power supplies.

According to the semiconductor integrated circuit, it is possible to reduce wiring impedance by mounting external parts at the nearest point possible to the semiconductor integrated circuit.

In addition, according to the semiconductor integrated circuit, since wirings connected between DC/DC converters and external parts may be shortened, it is possible to reduce radiation noise due to switching noise occurring in the wiring portion for connecting the DC/DC converters and the external parts.

According to the power supply including the semiconductor integrated circuit, for example, power conversion efficiency of the DC/DC converters may not deteriorate.

### OTHER EMBODIMENTS

As described above, the present disclosure has been illustrated by way of some embodiments, but the description and drawings which constitute a part of this disclosure are exemplary and should not be construed to limit the present disclosure. Various alternative embodiments, examples, and operation techniques will be apparent to those skilled art from this disclosure.

Thus, the present disclosure includes other different embodiments which are not described herein. For example, the methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

According to the present disclosure, it is possible to provide a semiconductor integrated circuit which is capable of suppressing parasitic impedance occurring between connections of the semiconductor integrated circuit and external parts, and a power supply including the semiconductor integrated circuit.

### INDUSTRIAL APPLICABILITY

The semiconductor integrated circuit and the power supply according to the embodiment may be applied to the general electronic equipment including smartphones, notebook PCs, tablet PCs, e-books, etc.

What is claimed is:

1. A semiconductor integrated circuit comprising:
a die pad region;
a plurality of external lead pins arranged in a peripheral region of the die pad region; and
a DC/DC converter arranged in a corner region of the die pad region.

2. The semiconductor integrated circuit of claim 1, further comprising a logic circuit arranged on the die pad region and configured to supply a control signal to the DC/DC converter.

3. The semiconductor integrated circuit of claim 1, wherein output of the DC/DC converter is connected to an inductance.

4. The semiconductor integrated circuit of claim 3, wherein the semiconductor integrated circuit and the inductance are arranged on a printed circuit board.

5. The semiconductor integrated circuit of claim 4, wherein the plurality of external lead pins provides space for mounting other wirings or parts on the printed circuit board.

6. The semiconductor integrated circuit of claim 4, wherein the DC/DC converter comprises a complementary output circuit including a p channel MOSFET and an n channel MOSFET.

7. The semiconductor integrated circuit of claim 6, wherein the plurality of external lead pins comprises:
a power pin;
a ground pin; and
an output pin connected to the output of the DC/DC converter,
wherein a source of the p channel MOSFET is connected to the power pin, a source of the n channel MOSFET is connected to the ground pin, and a drain of the p channel MOSFET and a drain of the n channel MOSFET is connected to the output pin.

8. The semiconductor integrated circuit of claim 7, wherein the number of the output pins is at least two.

9. The semiconductor integrated circuit of claim 7, further comprising:
a power wiring; and
an output capacitor,
wherein the output pin is connected to a first electrode of the inductance via the power wiring and a second electrode of the inductance is connected to the output capacitor.

10. The semiconductor integrated circuit of claim 9, further comprising a ground electrode pattern arranged on the printed circuit board.

11. The semiconductor integrated circuit of claim 10, further comprising a snubber capacitor arranged between the power pin and the ground electrode pattern.

12. The semiconductor integrated circuit of claim 10, wherein the output capacitor is arranged between the second electrode of the inductance and the ground electrode pattern.

13. A power supply comprising the semiconductor integrated circuit of claim 1.
